(19) United States
(12) Patent Application Publication
(10) Pub. No.: US 2001/0052493 A1
(43) Pub. Date: Dec. 20, 2001

(54) Sediment collection header apparatus

(75) Inventors: William B. Bryan, Sandy, UT (US); Brad Hansen, Holladay, UT (US); Patrick Laidlaw, Salt Lake City, UT (US); Terry R. Price, Bountiful, UT (US); John W. Thorum, Salt Lake City, UT (US)

Correspondence Address: R. Neil Sudol, Colman Sudol Sapone, P.C., 14th Floor, 708 Third Avenue, New York, NY, 10017, US

(73) Assignee: Baker Hughes Incorporated

(21) Appl. No.: 09/740,333

(22) Filed: Dec. 18, 2000

Related U.S. Application Data
(60) Provisional application No. 60/169,577, filed on Dec. 8, 1999.

(51) Int. Cl. B01D 12/00; B01D 17/00

(52) U.S. Cl. 210/513

(57) ABSTRACT

A header conduit assembly for a sediment collecting apparatus includes a tubular member having a plurality of mutually spaced (suction) orifices disposed in a linear array extending parallel to an axis of the tubular member. The conduit assembly further includes at least one elongate deflector member mounted to the tubular member in effective proximity to at least some of the orifices to guide sediment toward the orifices during a sediment evacuation process. Preferably, the deflector member extends parallel to the axis of the tubular member. Inasmuch as the tubular conduit member extends perpendicularly to a direction of movement of the conduit assembly on the floor of a clarification basin or tank, the deflector is oriented orthogonally to the path of the conduit assembly.

### CROSS-REFERENCE TO A RELATED APPLICATION

This application relies for priority purposes on U.S. provisional application No. 60/169,577 filed Dec. 8, 1999.

### BACKGROUND OF THE INVENTION

This invention relates generally to water and wastewater treatment systems. In particular, this invention relates to a sludge removal assembly for use in a water and wastewater treatment system. More particularly, this invention relates to an improved suction header design and assembly for use in a water and wastewater treatment system.

As is well known in the art of water and wastewater treatment, basins or tanks are used to collect certain solids and particulates which are suspended in a liquid such as water. The particulate matter is drawn by gravity to collect along a floor of a clarification basin or tank. The settled material, commonly known as “sludge,” is removed from the bottom of the clarification basin or tank by suction applied through a header conduit which travels along the floor of the tank. As disclosed in U.S. Pat. No. 4,401,576 to Meurer, the header conduit is attached to a tractor which moves along the basin floor along a fixed track under the action of pressurized fluid.

Various attempts have been made to incrementally improve the performance of suction header conduits. U.S. Pat. No. 5,772,885 to Sarrouh, for example, is directed to a suction removal header having an obtuse angled header shape and a large header cross-sectional width dimension. Internal annular passages are provided for equalizing pressure distribution inside the header, to improve flow distribution across all intake holes provided in the header conduit. Flow splitters are provided below the header.

U.S. Pat. No. 5,914,049 to Brauch et al. discloses a header conduit provided with inlet passageways which are disposed so as to direct sludge flow into the conduit along a path that is tangential to the inner surface of the conduit.

### SUMMARY OF THE INVENTION

The present invention provides an improved header assembly for use in a water and wastewater treatment system. More particularly, the present invention provides a header assembly with improved bidirectional flow characteristics.

A header conduit assembly for a sediment collecting apparatus comprises, in accordance with the present invention, a tubular member having a plurality of mutually spaced (suction) orifices disposed in a linear array extending parallel to an axis of the tubular member. The conduit assembly further comprises at least one elongate deflector member mounted to the tubular member in effective proximity to at least some of the orifices to guide sediment toward the orifices during a sediment evacuation process. Preferably, the deflector member extends substantially parallel to the axis of the tubular member. Inasmuch as the tubular conduit member extends substantially perpendicularly to a direction of movement of the conduit assembly on the floor of a clarification basin or tank, the deflector is oriented substantially orthogonally to the path of the conduit assembly.

In several embodiments of the present invention, the tubular member has the shape of a right rectangular prism. Thus, the cross-section of the tubular member is rectangular or square. Preferably, the suction orifices in the tubular member are disposed more closely to one longitudinal edge of the tubular member than to other edges thereof. In at least two embodiments, the tubular member is disposed so that the one longitudinal edge is located more closely than the other edges to the floor of the clarification tank. In other words, the side walls or panels of the tubular member are oriented at acute angles to the clarification tank floor so that the cross-section tubular member appears in a diamond or rhombus configuration. In one specific preferred embodiment of the invention, the orifices coincide with the lowermost edge of the diamond-shaped tubular member, while the deflector member hangs substantially vertically from the lowermost edge of the tubular member. Accordingly, the orifices are each partially located in each of two contiguous side walls or panels of the tubular member. Alternatively, the orifices may be disposed solely in one lower side wall and spaced slightly from the lowermost edge of the tubular member. In that case, a second set of orifices, disposed in a linear array slightly spaced from the lowermost longitudinal edge, is provided in the other lower side wall or panel of the tubular member.

In another preferred embodiment of the present invention, the tubular member with a rectangular or square cross-section is disposed so that a side wall is parallel to the floor of the clarification tank. That lowermost wall is preferably provided with two linear arrays of suction orifices, the deflector being attached to the lowermost wall between the two arrays of orifices.

Pursuant to another feature of the present invention, pertaining exemplarily but not exclusively to this embodiment, the deflector member is movably connected to the tubular member, for example, via a pivot pin. The movement, or specifically pivoting, of the deflector member may be implemented passively in response to fluid pressure. Alternatively, the movement of the deflector member may be actively controlled by a pneumatic, hydraulic or other type of drive. In another variant, the deflector is shifted mechanically upon coming into contact with an arrest or stop at a side wall of the clarification basin or tank.

The deflector may include a plurality of guide vanes. Where the guide vanes are movably connected to the tubular member, the guide vanes may be rigidly secured to one another.

In another specific embodiment of the present invention, the tubular member has three side walls or panels defining a cross-sectionally triangular plenum. The tubular member is mounted to a tractor or propulsion body so that two longitudinal edges are located more proximately than the third longitudinal edges to the clarification tank floor. These two edges are preferably disposed at the same distance from the floor so that a lowermost wall or panel of the tubular member extends parallel to the floor. The lowermost wall or panel of the tubular member is provided with two parallel linear array of suction orifices each disposed more closely to a respective one of the two lower longitudinal edges of the tubular member than to the other lower longitudinal edge.

In accordance with another feature of the present invention, the deflector member is curved or arcuate. Where the deflector member is one of two curved or arcuate deflector members, each deflector member has a concave surface facing away from the other deflector member, the deflector members being connected to the tubular member at a location between two linear arrays of suction orifices or inlets. Particularly in the curved or arcuate configuration, the deflector member may be provided on the respective concave surfaces with a plurality of grooves or channels extending toward respective suction orifices.

In accordance with a further feature of the present invention, where the tubular member is provided with at least two rows or linear arrays of suction orifices, a cover plate is movably connected to the tubular member to alternately cover a first set of orifices and a second set of orifices. The cover plate is shifted to uncover the orifices on an upstream of leading side of the tubular member and to cover the orifices on a downstream or trailing side of the tubular member. The shifting may be implemented passively in response to fluid pressure. Alternatively, the movement of the cover plate may be actively controlled by a pneumatic, hydraulic or other type of drive. The movement of the cover plate in concert or synchronization with the reciprocation of the sludge collection header assembly along the clarification tank floor facilitates the sludge collection process by enhancing the suction pressure at the upstream or leading set of suction orifices.

### BRIEF DESCRIPTION OF THE DRAWINGS

FIG. 1 is a side elevational view of a header conduit assembly for a sludge removal assembly for use in a water and wastewater treatment system, in accordance with the present invention.

FIG. 2 is an end elevational view of the header conduit assembly of FIG. 1, showing disposition of the conduit assembly relative to a floor and sludge layer in a water and wastewater treatment system.

FIG. 3 is a perspective view of the header conduit assembly of FIGS. 1 and 2.

FIG. 4 is a partial cross-sectional view taken along line IV-IV in FIG. 1.

FIG. 5 is a schematic perspective view of the header conduit assembly of FIGS. 1-4, showing the assembly mounted to a tractor or propulsion body for motion along a track.

FIG. 6 is a view similar to FIG. 4, showing a modification of the header conduit assembly of FIGS. 1-5.

FIG. 7 is a side elevational view of another header conduit assembly in accordance with the present invention.

FIG. 8 is a transverse cross-sectional view taken along line VIII-VIII in FIG. 7, showing disposition of the conduit assembly relative to a floor and sludge layer in a water and wastewater treatment system.

FIG. 9 is a perspective view of the header conduit assembly of FIGS. 7 and 8.

FIG. 10 is a cross-sectional view similar to a portion of FIG. 8, on a larger scale.

FIG. 11 is a view similar to FIG. 8, showing a modification of the header conduit assembly of FIGS. 7-10.

FIG. 12 is a view similar to FIG. 11, showing a further modification of the header conduit assembly of FIGS. 7-10.

FIG. 13 is a view similar to FIGS. 11 and 12, showing yet another modification of the header conduit assembly of FIGS. 7-10.

FIG. 14 is a perspective view of the header conduit assembly of FIG. 13.

FIG. 15 is a perspective view of another header conduit assembly in accordance with the present invention, showing a multiple-vane deflector pivotably mounted to a tubular member.

FIG. 16 is a transverse cross-sectional view of the header conduit assembly of FIG. 15, showing the deflector in one pivoted orientation corresponding to header motion to the left.

FIG. 17 is a transverse cross-sectional view of the header conduit assembly of FIG. 15, showing the deflector in another pivoted orientation corresponding to header motion to the right.

FIG. 18 is a transverse cross-sectional view similar to FIGS. 16 and 17, showing a modification of the header conduit assembly of FIGS. 15-17, with a multiple-vane deflector in a relaxed or neutral position.

FIG. 19 is a partial bottom elevational view of another header conduit assembly in accordance with the present invention.

FIG. 20 is a transverse cross-sectional view taken along line XX-XX in FIG. 19.

FIG. 21 is a side elevational view of yet another header conduit assembly in accordance with the present invention.

FIG. 22 is a partial perspective view of the header conduit assembly of FIG. 21.

FIG. 23 is a transverse cross-sectional view taken along line XXIII-XXIII in FIG. 21.

FIG. 24 is a partial transverse cross-sectional view, on an enlarged scale, taken along line XXIII-XXIII in FIG. 21.

FIG. 25 is a bottom plan view of the header conduit assembly of FIGS. 21-23.

In several cross-sectional views in the drawings, cross-hatching has been omitted for simplicity.

### DESCRIPTION OF THE PREFERRED EMBODIMENTS.

As illustrated in FIGS. 1-5, a header conduit assembly 30 comprises a tubular pipe or conduit 32 of rectangular or square cross-section having four elongate side walls or panels 34-37 joined to one another at four longitudinal edges 38-41 and defining an elongate plenum 42. A pair of rectangular or square end plates 44 (only one shown) are attached to side walls 34-37 at opposite ends thereof. Lower side walls 34 and 35 are provided along their common edge 38 with a plurality of mutually spaced suction orifices or openings 46 disposed in a linear array extending at least substantially parallel to an axis 47 of conduit 32. Orifices 46 include a first portion 46′ in side wall 34 and a second portion 46″ in side wall 35. Orifices 46 are depicted as having a common spacing S, although the spacing of orifices 46 may vary along the linear array.

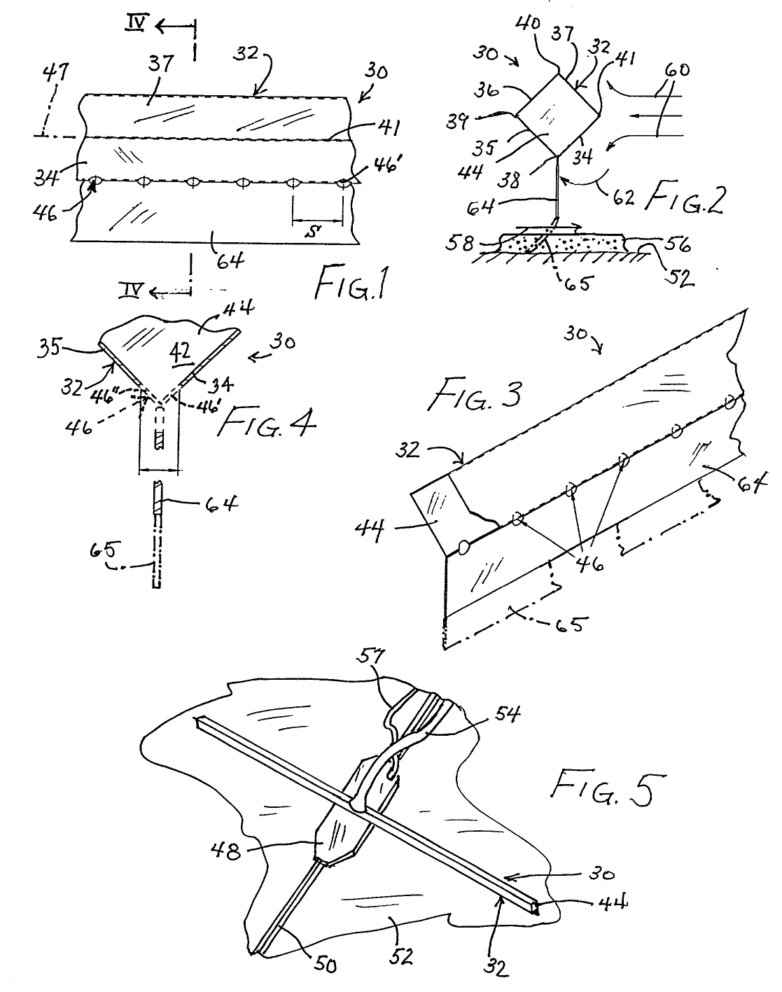

Tubular conduit 32 is mounted to a tractor or propulsion body 48, as shown in FIG. 5, for travel therewith in alternately opposite directions along a track 50 disposed on a floor or lower surface 52 of a clarification or settling tank (not separately designated). A suction hose 54 is connected to conduit 32 for evacuating the contents thereof and for pulling sludge 56 (FIG. 2) from a sludge bed (not separately designated) into the tubular pipe or conduit through orifices 46. An air supply hose 57 is connected to tractor 48 for providing pneumatic motive power thereto.

As shown in FIG. 2, during motion of header conduit assembly 30 in a direction 58, fluid flow is divided at the leading edge 41 of conduit 32, as indicated by arrows 60. The lower part of the flow is guided to suction orifices 46, as indicated by an arrow 62. The guiding of particle-laden fluid to suction orifices 46 is enhanced by an optional deflector vane 64 rigidly connected to conduit 32 so as to hang vertically from lower longitudinal edge 38. Deflector vane 64 is provided along an upper edge (not designated) with a series of notches 61 which are aligned with respective orifices 46 for facilitating the flow of sediment-laden fluid to the orifices.

The guiding of fluid-carried particulate matter to orifices 46, with or without deflector vane 64, is the same regardless of the direction of motion of tractor 48 along track 50. The header conduit assembly of FIGS. 1-5 thus has enhanced bidirectional operative capacity.

As depicted in FIGS. 3 and 4, deflector vane 64 may be provided with an elongate elastomeric squeegee member or wiper blade 65 for assisting in clearing floor surface 52 of sediment or sludge 56. As shown in FIG. 2, wiper blade 65 may be long enough to engage floor surface 52 and flexible to deform during motion of header conduit assembly 30. In an alternative design, wiper blade 65 is replaced by a rigid wiper plate (not shown) which is adjustably mounted to deflector vane 64 to enable an adjustment in the position of the rigid wiper plate relative to an underlying floor surface.

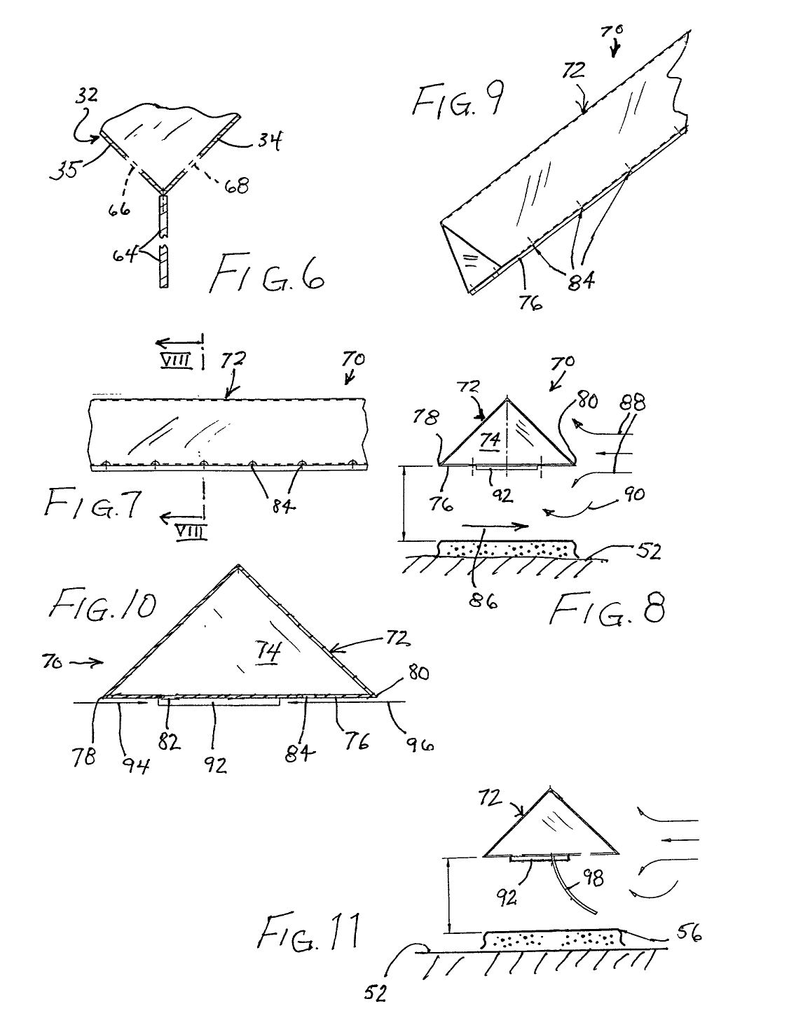

FIG. 6 illustrates a modification of the header conduit assembly 30 of FIGS. 1-5, wherein orifices 46 have been replaced by two sets of orifices 66 and 68 disposed at lower ends of respective side walls 34 and 35. Orifices 66 are mutually spaced from one another with a common spacing (e.g., S in FIG. 1) and are arranged in a linear array extending parallel to lower longitudinal pipe edge 38 and concomitantly axis 47 (FIG. 1). Similarly, orifices 68 are separated from one another by a uniform distance and are disposed in a straight line extending parallel to lower longitudinal pipe edge 38 and concomitantly axis 47 (FIG. 1). Orifices 66 and 68 are located significantly more closely to lower longitudinal edge 38 than to the other longitudinal edges 39-41 of conduit 32.

As depicted in FIGS. 7-10, another header conduit assembly 70 attachable to tractor 48 comprises a pipe or conduit 72 defining a cross-sectionally triangular plenum 74. Conduit 72 has lower wall or panel 76 flanked by two longitudinal edges 78 and 80. Conduit 72 is mounted to a tractor (see 48 in FIG. 5) so that lower wall or panel 76 is disposed parallel to a floor surface (52, FIG. 5). Lower wall or panel 76 is provided with a first linear array of suction orifices 82 and a second linear array of suction orifices 84. Orifices 82 are disposed proximately to edge 78, while orifices 84 are located near edge 80.

As illustrated in FIG. 8, during motion of header conduit assembly 70 in a direction 86 over sludge 56 settled on floor 52 of a clarification or settling tank, fluid flow is divided at the leading edge 80 of conduit 72, as indicated by arrows 88. A lower portion of the flow heads toward suction orifices 84, as indicated by an arrow 90. This flow of particle-laden fluid to suction orifices 84 is enhanced by an optional cover plate 92 movably connected to conduit 72 so as to selectably underlie one set of orifices 82 or 84, depending on the direction of motion of the header conduit assembly 70 along track 50 (FIG. 5). FIG. 8 depicts cover plate 92 in a neutral or middle position. However, during motion of header conduit assembly 70 in direction 86, cover plate 92 is located in a trailing position so as to overlie the trailing or downstream set of orifices 82, as depicted in FIG. 10. The shifting of cover plate 92 may be implemented by the fluid pressure gradient, indicated by arrows 94 and 96. Alternatively, an active mechanism such as a hydraulic or pneumatic cylinder (not shown) may be connected to plate 92 for shifting the same.

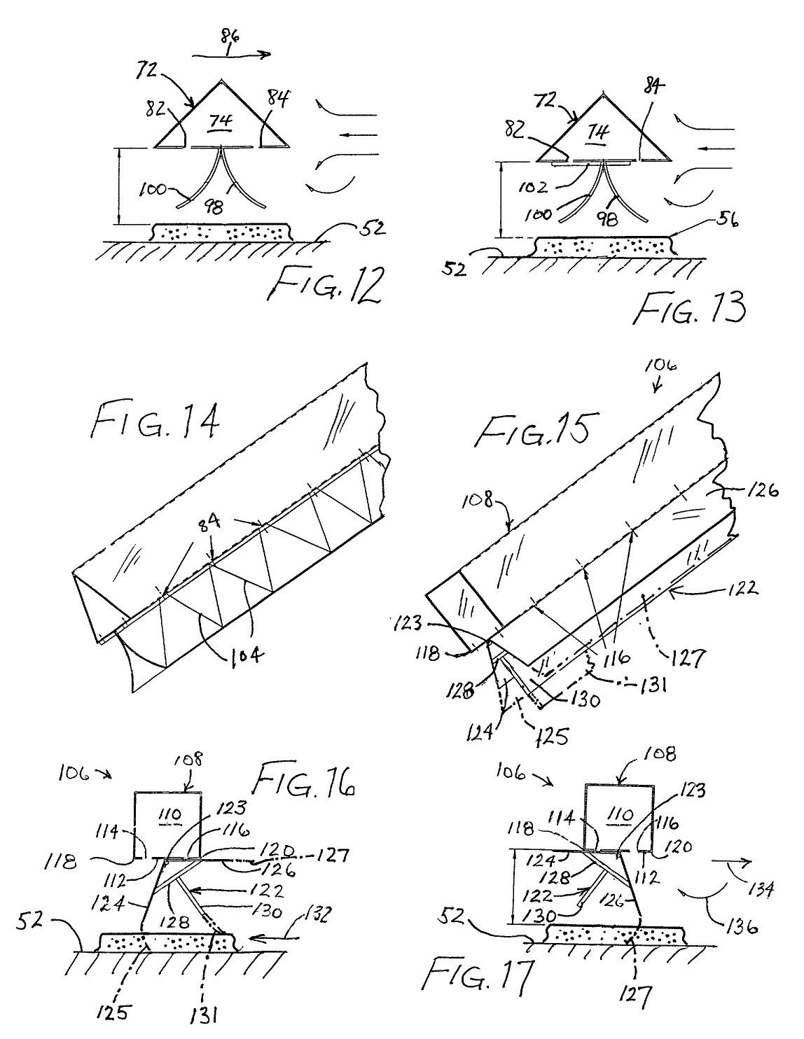

FIG. 11 shows a modification of the header assembly embodiment of FIGS. 7-10, wherein a rigid deflector vane 98 is connected to lower wall or panel 76 for guiding fluid-carried particulate matter to suction orifices 84. Deflector vane 98 is arcuate or, more specifically, concave in the direction of fluid flow and enables the header assembly to pick up settled sludge particles closer to clarification tank floor 52. FIG. 12 shows an additional modification of the header assembly of FIGS. 7-10, wherein an additional rigid curved or arcuate deflector vane 100 is connected to lower wall or panel 76 for guiding fluid-carried particulate matter to suction orifices 82 during motion of header assembly 70 in a direction opposite to direction 86. Vane 100 also enables the suction uptake of sludge particles closer to floor surface 52. As illustrated in FIG. 13, the modified embodiment of FIG. 12 may be provided with a sliding cover plate 102 similar to cover plate 92. As discussed above with reference to plate 92, the position of cover plate 102 may be determined by the direction of travel of header assembly 70. Alternatively, an active mechanism such as a hydraulic or pneumatic cylinder (not shown) may be connected to plate 102 for shifting the same. As shown in FIG. 14, deflector vanes 98 and 100 are optionally formed with a plurality of grooves 104 for directing the flow of particulate material generally towards respective orifices 82 and 82.

FIGS. 15-17 depict another header conduit assembly 106 which may be mounted to tractor 48 (FIG. 5) for reciprocating motion therewith along track 50. A tubular conduit 108 defines an elongate right rectangular plenum or space 110 and is provided along a lower wall or panel 112 with a first group of suction orifices 114 and a second group of suction orifices 116, each group of orifices 114 and 116 being arranged in a respective linear array extending proximately to a respective longitudinal edge 118 and 120 of lower wall or panel 112. Conduit 108 is mounted ot tractor 48 (FIG. 5) so that edges 118 and 120 are parallel to and equispaced from clarification tank floor 52 during a sludge collection operation. Header conduit assembly 106 is provided with a deflector structure 122 swingably mounted to lower wall or panel 112 via a pivot pin or rod 123. Deflector structure 122 comprises two rigid elongate rectangular vanes 124 and 126 connected to one another via one or more braces or brackets 128. A third vane 130 is connected to brace or bracket 128 midway between vanes 124 and 126.

When header conduit assembly 106 is moving in the direction of arrow 132 in FIG. 16, deflector structure 122 pivots so that vane 126 covers orifices 116, as shown in FIG. 16. Conversely, when header conduit assembly 106 is moving in the direction of arrow 134 in FIG. 17, deflector structure 122 pivots so that vane 124 covers orifices 114, as shown in FIG. 17. Deflector vanes 124 and 126 thus perform the dual function of covering the downstream or trailing set of orifices 114 or 116, thereby increasing the suction at the upstream or leading set of orifices 116 or 114, and guiding or directing particle-bearing fluid to the upstream or leading orifices, as represented in FIG. 17 by arrow 136. The shifting of deflector structure 122 may be induced in a passive manner by a change in fluid pressure gradient upon a reverse in direction of movement of tractor 48 (FIG. 5) and the header conduit assembly 106 connected thereto. In that case, vane 130 serves not only to block fluid flow under deflector structure 122 and enhance fluid flow guidance but also to aid in rotating deflector structure 122 about pivot rod 123. Alternatively, an active mechanism such as a hydraulic or pneumatic cylinder (not shown) may be connected to deflector structure 122 for rotating the same about pivot rod 123.

As depicted in FIGS. 15 and 16, deflector structure vanes 124, 126 and 130 may be provided with respective elongate squeegee members 125, 127 and 131 for assisting in clearing floor surface 52 of sediment or sludge 56. As shown in FIG. 2, squeegee members 124 and 126 engage floor surface 52 and deform during motion of header conduit assembly 106 in opposing directions along the floor of a sediment collection or clarification tank. Squeegee member 131 engages floor surface 52 and deforms during a change in the direction of motion of header conduit assembly 106 along floor surface 52. Squeegee members 125, 127 and 131 also assist in pivoting of deflector structure 122 at the opposite ends of a path of header conduit assembly 106.

Other header conduit assemblies disclosed herein may be provided with respective flexible squeegee members engageable with the floor surface 52.

A header conduit assembly 138 shown in FIG. 18 is similar to assembly 106 of FIGS. 15-17, except that cross-sectionally square conduit 108 has been replaced by a cross-sectionally triangular pipe or conduit 140. As discussed above with reference to FIGS. 15-17, conduit 140 is provided with along a lower wall or panel 142 with a first group of suction orifices 144 and a second group of suction orifices 146, each group of orifices 144 and 146 being arranged in a respective linear array extending proximately to a respective longitudinal edge 148 and 150 of lower wall or panel 142. Deflector structure 122 is the same in the modified embodiment of FIG. 18.

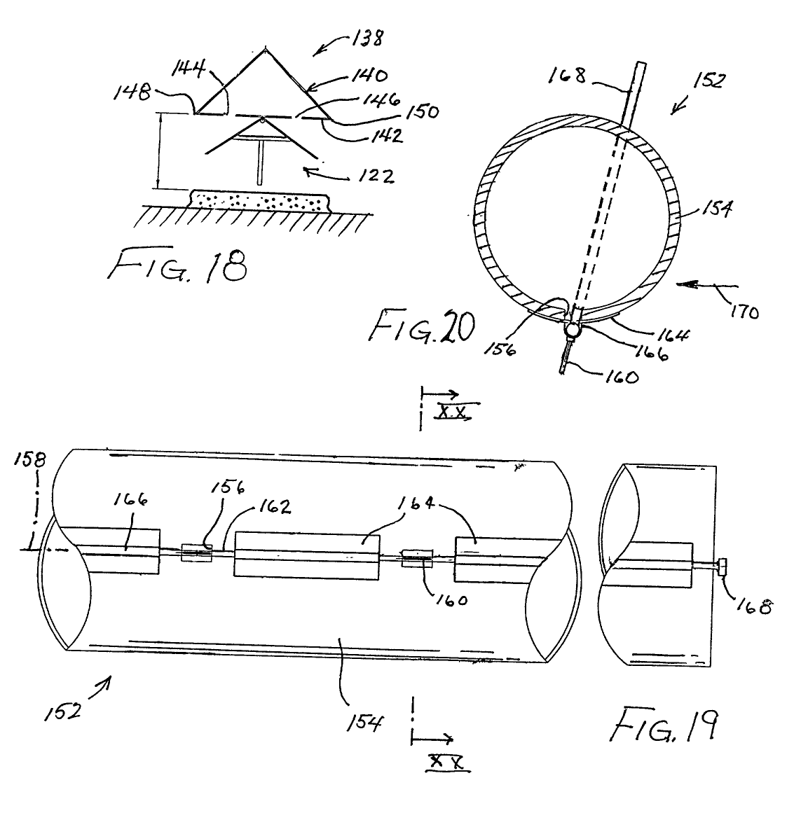

As illustrated in FIGS. 19 and 20, another header conduit assembly 152 for attachment to tractor 48 (FIG. 5) of a sludge collection apparatus comprises an elongate tubular member in the form of a cylindrical conduit 154 provided along a lower side with a plurality of suction orifices 156 disposed in a linear array parallel to an axis 158 of the conduit 154. A plurality of deflector vanes 160 are attached over respective suction orifices 156 to a pivot rod 162 extending longitudinally along the lower side of conduit 154. Rod 162 is rotatably secured to conduit 154 via a plurality of curved mounting plates 164 and bearings 166. Rod 162 is rigidly attached to an actuator lever 168 which may be shifted by a pair of shifting devices (not illustrated) disposed at opposite ends of a travel path of tractor 48 (FIG. 5). At the ends of the travel path, the shifting devices pivot actuator lever 168 to thereby turn deflector vanes 160 so that their lower ends point in the travel direction 170 of the header conduit assembly 152. The shifting devices may operate passively in cooperation with the motion or change in direction of motion of the tractor or actively under pneumatic or hydraulic or even electrical power. It is to be noted that the header conduit assembly of FIGS. 18 and 19, as well as all of the header conduit assemblies disclosed herein are bidirectionally effective. In the event that deflector vanes 160 and the associated pivoting structure are omitted from header conduit assembly 152, cylindrical conduit 154 also provides a bidirectional feed of particle-laden fluid to suction orifices 156.

FIGS. 21-25 depict a further header conduit assembly 172 which is a modification of assembly 30 of FIGS. 1-5. A tubular pipe or conduit 174 of rectangular or square cross-section has four elongate side walls or panels 176-179 joined to one another at four longitudinal edges 180-183 and defining an elongate plenum 184 having a right rectangular prismatic shape. A pair of rectangular or square end plates 186 (only one shown) are attached to side walls 176-179 at opposite ends thereof. Lower side walls 176 and 177 are provided along their common edge 180 with a plurality of mutually spaced suction orifices or openings 188 disposed in a linear array extending parallel to an axis 190 of conduit 174.

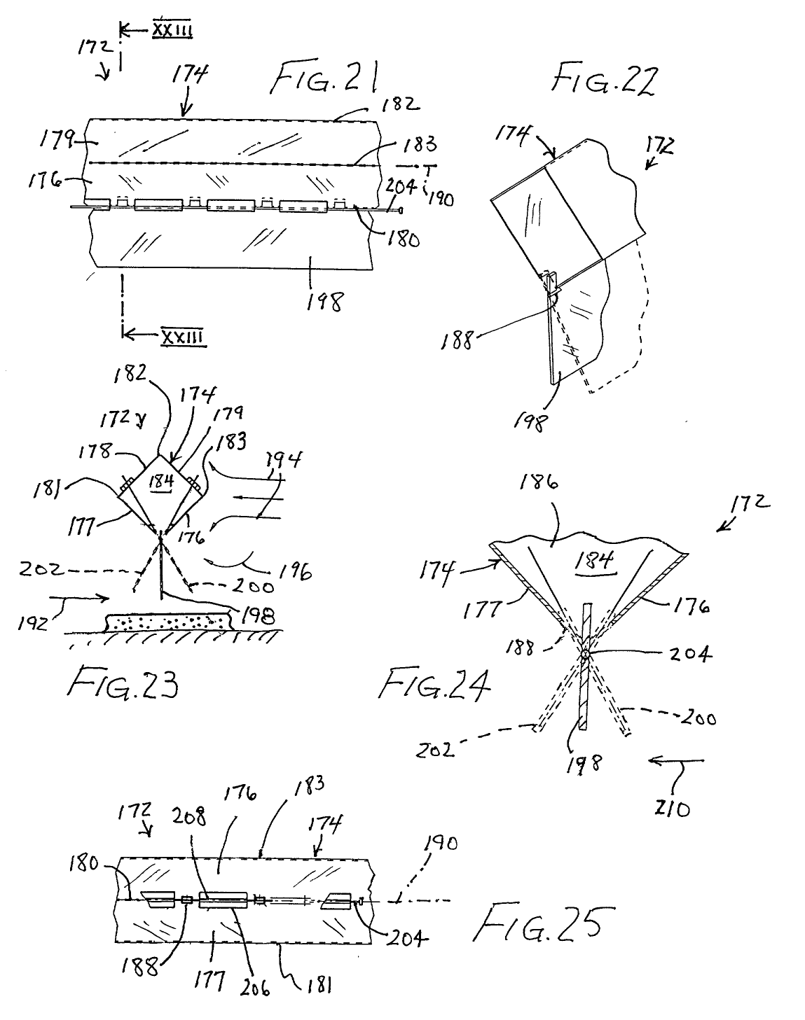

As shown in FIG. 23, during motion of header conduit assembly 174 in a direction 192, fluid flow is divided at the leading edge 183 of conduit 174, as indicated by arrows 194. The lower part of the flow is guided to suction orifices 188, as indicated by an arrow 196. The guiding of particle-laden fluid to suction orifices 188 is enhanced by one or more deflector vanes 198 tiltably connected to conduit 174 along lower edge 180 thereof so as to pivot between two inclined orientations 200 and 202. More specifically, vane or vanes 198 are tiltably mounted to a pivot rod 204 in turn rotatably secured to conduit 174 along lower edge 180 thereof by brackets 206 and bearings 208. Orientations 200 and 202 are assumed by deflector vane(s) when header conduit assembly 172 is traveling in direction 192 or 210, respectively. The shifting of deflector vane(s) 198 is effectuated by, for example, a mechanical pusher or a hydraulic or pneumatic cylinder.

It is to be noted that the word “tubular” as used herein denotes a hollow elongate member of virtually any cross-section, including without limitation, circular, rectangular, square, diamond or rhombus, triangular, etc.

It is to be understood that the various deflector vanes disclosed herein may extend into a sludge bed, depending on the particular operating characteristics. Generally, the sludge bed will not have a well defined boundary and the density of the sediment particles will vary throughout the bed, the density increasing towards the floor 52 of the clarification or settling tank. The sludge bed may be up to two or three feet deep so that the entire header conduit assembly is submerged in the sludge bed. Nevertheless, the various embodiments of a header conduit assembly disclosed herein provide enhanced operational efficacy in the collection of sediment.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A header conduit assembly for a sediment collecting apparatus, comprising:
a tubular member having a plurality of mutually spaced orifices disposed in a substantially linear array extending essentially parallel to an axis of said tubular member; and
at least one elongate deflector member mounted to said tubular member in effective proximity to at least some of said orifices to guide sediment toward said orifices during a sediment evacuation process, said deflector member extending substantially parallel to said axis.

2. The header conduit assembly defined in claim 1 wherein said tubular member has a rectangular cross-section and a plurality of longitudinally extending edges, said orifices being disposed more closely to one of said edges than to others of said edges.

3. The header conduit assembly defined in claim 2 wherein said orifices are first orifices spaced from said one of said edges, said tubular member being provided with a plurality of second orifices also disposed more closely to said one of said edges than to others of said edges.

4. The header conduit assembly defined in claim 3 wherein said tubular member has a pair of side walls or panels joined to one another along said one of said edges, said first orifices being disposed in one of said side walls or panels and said second orifices being disposed in the other of said side walls or panels.

5. The header conduit assembly defined in claim 2 wherein said orifices are disposed along said one of said edges and coincide therewith.

6. The header conduit assembly defined in claim 2 wherein said deflector member is planar and is connected to said tubular member along said one of said edges.

7. The header conduit assembly defined in claim 2 wherein said tubular member has four side walls or panels defining an internal plenum, further comprising means for mounting said tubular member to a tractor or propulsion body so that all of said side walls or panels are inclined at an acute angle to a ground surface.

8. The header conduit assembly defined in claim 1 wherein said tubular member has three side walls or panels defining a cross-sectionally triangular plenum, said orifices being first orifices disposed in one of said side walls or panels, said tubular member being provided with a plurality of second orifices disposed in a linear configuration or array in said one of said side walls or panels.

9. The header conduit assembly defined in claim 8 wherein said deflector member is curved or arcuate.

10. The header conduit assembly defined in claim 9 wherein said deflector member is one of two curved or arcuate deflector members, each one of said deflector members having a concave surface facing away from the other deflector member, said deflector members being connected to said tubular member at a location between said predetermined arrangement and said linear configuration.

11. The header conduit assembly defined in claim 10 wherein said deflector members are provided on the respective concave surfaces with a plurality of grooves or channels extending toward respective ones of said orifices.

12. The header conduit assembly defined in claim 8, further comprising a cover plate movably connected to said tubular member to alternately cover said first orifices and said second orifices.

13. The header conduit assembly defined in claim 8 wherein said deflector members are provided with a plurality of grooves or channels extending toward respective ones of said orifices.

14. The header conduit assembly defined in claim 1 wherein said deflector member includes a plurality of vanes fixed to one another.

15. The header conduit assembly defined in claim 14 wherein said deflector member is pivotably mounted to said tubular member.

16. The header conduit assembly defined in claim 1 wherein said deflector member is movably mounted to said tubular member.

17. The header conduit assembly defined in claim 16, further comprising a drive operatively connected to said deflector member for shifting said deflector member in accordance with a direction of motion of the header conduit assembly during a cleaning or sediment collecting operation.

18. The header conduit assembly defined in claim 16 wherein said deflector member is connected to a bidirectional control or actuator lever which projects from said tubular member.

19. The header conduit assembly defined in claim 1 wherein said deflector member is fixed to said tubular member.

20. The header conduit assembly defined in claim 1 wherein said deflector member is planar.

21. The header conduit assembly defined in claim 1 wherein said deflector member is arcuate.

22. The header conduit assembly defined in claim 1 wherein said predetermined arrangement is a linear arrangement, said tubular member having a plurality of side walls or panels, said orifices being first orifices disposed in one of said side walls or panels, said tubular member being provided with a plurality of second orifices disposed in a linear configuration in said one of said side walls or panels said linear configuration extending parallel to said linear arrangement, further comprising a cover plate movably connected to said tubular member to alternately cover said first orifices and said second orifices.

23. The header conduit assembly defined in claim 1 wherein said tubular member has a rectangular configuration and four side walls or panels defining an internal plenum, further comprising means for mounting said tubular member to a tractor or propulsion body so that all of said side walls or panels are inclined at an acute angle to a ground surface.

24. The header conduit assembly defined in claim 1 wherein said deflector member is provided with a plurality of grooves or channels extending toward respective ones of said orifices.

25. The header conduit assembly defined in claim 1 wherein said deflector member is provided with a flexible squeegee member for pushing sediment along a floor of a sediment collection or clarification tank.

26. A header conduit for a sediment collecting apparatus, comprising:
a tubular member having an axis, said tubular member being provided with a plurality of mutually spaced first orifices disposed in a first linear array extending parallel to said axis, said tubular member being further provided with a plurality of mutually spaced second orifices disposed in a second linear array disposed parallel to said axis; and
a cover member movably mounted to said tubular member so as to shift between (a) a first position overlying said first orifices and uncovering said second orifices and (b) a second position overlying said second orifices and uncovering said first orifices.

27. The header conduit assembly defined in claim 26, further comprising at least one deflector member mounted to said tubular member in effective proximity to at least some of said orifices to guide sediment toward said orifices during a sediment evacuation process.

28. The header conduit assembly defined in claim 27 wherein said deflector member is a rigid component fixed to said tubular member.

29. The header conduit assembly defined in claim 27 wherein said deflector member is movably mounted to said tubular member.

30. The header conduit assembly defined in claim 27 wherein said deflector member is provided with a flexible squeegee member for pushing sediment along a floor of a sediment collection or clarification tank.

31. The header conduit assembly defined in claim 26 wherein said tubular member includes a planar wall or panel, said first orifices and said second orifices being disposed in said planar wall or panel, said cover member being a plate slidably connected to said tubular member.

32. The header conduit assembly defined in claim 31 wherein said tubular member has a plenum with a cross-section in a shape taken from the group consisting of a triangle and a rectangle.

33. A sediment collecting apparatus with a header conduit assembly, comprising:
a tractor or propulsion body defining a plane parallel to a ground surface in a use position of said tractor or propulsion body; and
a tubular member having an axis, said tubular member including a plurality of side walls or panels defining an elongate plenum of a rectangular cross-section, said tubular member being mounted to said tractor or propulsion body so that all of said side walls or panels are inclined at an acute angle to said plane, said tubular member being provided with a plurality of mutually spaced orifices disposed in a substantially linear array parallel to said axis.

34. The header conduit assembly defined in claim 33 wherein said tubular member has a plurality of longitudinally extending edges, said orifices being disposed more closely to one of said edges than to others of said edges.

35. The header conduit assembly defined in claim 34 wherein said orifices are first orifices spaced from said one of said edges, said tubular member being provided with a plurality of second orifices also disposed more closely to said one of said edges than to others of said edges.

36. The header conduit assembly defined in claim 35 wherein said tubular member has a first side wall or panel and a second side wall or panel joined to one another along said one of said edges, said first orifices being disposed in said first side wall or panel and said second orifices being disposed in said second side wall or panel.

37. The header conduit assembly defined in claim 34 wherein said orifices are disposed along said one of said edges and coincide therewith.

38. The header conduit assembly defined in claim 33, further comprising at least one deflector member mounted to said tubular member in effective proximity to at least some of said orifices to guide sediment toward said orifices during a sediment evacuation process.

39. The header conduit assembly defined in claim 38 wherein said deflector member is planar and is connected to said tubular member along said one of said edges.

40. A sediment collecting apparatus with a header assembly, comprising:
a tractor or propulsion body; and
a tubular member having a plurality of mutually spaced orifices disposed in a predetermined arrangement, said tubular member being mounted to said tractor or propulsion body so that an axis of said tubular member extends substantially perpendicularly to a direction of motion of said tubular member during said sediment evacuation process, said predetermined arrangement being a linear arrangement extending substantially parallel to said axis,
said tubular member being provided with means for enabling a guiding of sediment to said orifices when said tractor or propulsion body and said tubular member travel in said direction of motion and when said tractor or propulsion body and said tubular member travel in a direction opposite to said direction of motion.

41. The header assembly defined in claim 40 wherein said means for enabling includes at least one deflector member mounted to said tubular member in effective proximity to at least some of said orifices to guide sediment toward said orifices during a sediment evacuation process.

42. The header assembly defined in claim 41 wherein said deflector member is movably mounted to said tubular member.

43. The header conduit assembly defined in claim 41 wherein said deflector member is provided with a flexible squeegee member for pushing sediment along a floor of a sediment collection or clarification tank.

44. The header assembly defined in claim 40 wherein said tubular member has four side walls or panels defining an internal plenum, said means for enabling including a mounting of said tubular member to said tractor or propulsion body so that all of said side walls or panel at an acute angle to a ground surface, said orifices at least proximately to a bottom edge of said tubular member.
